(19) United States
(12) Patent Application Publication
(10) Pub. No.: US 2007/0293649 A1
(43) Pub. Date: Dec. 20, 2007

(54) Process for preparing functionalised silanes and siloxanes

(75) Inventor: Bimal Pillai, Navimumbai (IN)

Correspondence Address: WEINGARTEN, SCHURGIN, GAGNEBIN & LEBOVICI LLP, TEN POST OFFICE SQUARE, BOSTON, MA, 02109, US

(73) Assignee: NOUVEAW EXPORTS PRIVATE LIMITED

(21) Appl. No.: 11/799,034

(22) Filed: Apr. 30, 2007

Related U.S. Application Data
(63) Continuation-in-part of application No. PCT/IB05/03184, filed on Oct. 24, 2005.

(30) Foreign Application Priority Data
Oct. 29, 2004 (IN) 1165/MUM/2004

(51) Int. Cl. C08G 77/14

(52) U.S. Cl. 528/33

(57) ABSTRACT

The present invention relates to a process for preparing functionalised silane or siloxane by modifying Si—O—Si bond, and more particularly, the present invention relates to an economical process to modify the Si—O—Si bond to Si—NH—Si and Si—OH functional groups.

This application is a continuation-in-part of PCT/IB2005/003184 filed Oct. 24, 2005, and claims priority to Indian application No. 1165/MUM/2004 filed Oct. 29, 2004, which is incorporated herein by reference.

### FIELD OF THE INVENTION

The present invention relates to an economical process to modify Si—O—Si bond, to incorporate desired functional group at the Si—O—Si bond.

### BACKGROUND OF INVENTION

Siloxanes—(R¹R²Si—O—SiR³R⁴)— are modified to add various functional groups at the Si—O—Si linkage. Since, the Si—O—Si being a stable linkage it is not very easy to incorporate different functional groups.

The present invention reveals a process by which desired functional groups like (—NH)—as in Hexamethyldisilazane (HMDS) and —OH as in hydroxy terminated polydimethylsiloxane fluids can be incorporated. But the use of this method is not limited to the addition of these functional groups and can be used to add many other functional groups too.

Following are the conventional and widely used methodology to produce modified siloxane. Hexamethyldisilazane (HMDS) is prepared from hexamethyldisiloxane (HMDO) using the following two steps:

Process I:

a) Reacting HMDO with anhydrous HCL in the presence of a dehydrating agent to produce trimethylchlorosilane (TMCS). In this, the dehydration of Reaction mixture is generally done using concentrated Sulfuric Acid which is allowed to dilute to ˜70%. The spent acid, which contains some organic impurities also, has to be disposed or concentrated using multiple stage evaporators. Anhydrous HCl, which is needed for the reaction with HMDO, is generally produced using one of the following processes.
   i. Dehydration of aq. HCl using CaCl₂ or Concentrated Sulfuric acid.
   ii. Electrolysis of NaCl, or distillation of aqueous HCl.
b) Reacting Ammonia with TMCS produced in step-a, to produce HMDS and Ammonium chloride
   Process II:

HMDS from Trimethylchlorosilane (TMCS) produced in the Direct process using Silicon metal and Methyl chloride. Trimethylchlorosilane (TMCS) is reacted with. ammonia to produce HMDS and Ammonium Chloride. This amination results in reduction of chlorine loop efficiency of chlorosilane plants and so regeneration of chloride as HCl is desirable in this process too.

The drawbacks of the existing process are, in case of Process I, where anhydrous HCl is used to replace oxygen with chloride ion.

Firstly, water is formed in the reaction so a dehydrating agent like 98% H₂SO₄ has to be added to absorb the water of reaction. This produces an effluent stream of dilute H₂SO₄.

Secondly some HMDO dissolves into the effluent stream and adds to losses. This in turn reduces the yield of the product.

Thirdly TMCS produced being a volatile compound is prone to losses. This in turn reduces the yield of the product.

To dehydrate commercially available aqueous HCl incurs a lot of money and energy which adds to the production cost.

Regarding the drawbacks of the Process II, the consequent amination in the reaction chain results in reduction of chlorine loop efficiency of chlorosilane plants, thus adding to the economic losses of the reaction process. This is because the chlorine which gets converted to ammonium salt, will have to be substituted by HCl for further chlorination of silicon.

Apart from that, some documents that cite various reactions with Silanes and Siloxanes are mentioned below:
1. JOURNAL OF THE AMERICAN CHEMICAL SOCIETY, vol. 67, no. 12, December 1945, pages 2272-2273
2. JOURNAL OF ORGANOMETALLIC CHEMISTRY, vol. 15, no. 1, November 1968, pages 77-87.
3. ANGEWANDTE CHEMIE, vol. 70, no. 15, 7 Aug. 1958, pages 469-470.
4. BULLETIN OF THE ACADEMY OF SCIENCES OF THE USSR, DIVISION OF CHEMICAL SCIENCES, vol. 26, 1977, pages 2174-2175.
5. BULLETIN DE LA SOCIETE CHIMIQUE DE FRANCE, vol. 3, 1986, pages 413-417.
6. JOURNAL OF THE AMERICAN CHEMICAL SOCIETY, vol. 68, no. 1, January 1946, page 156
7. JOURNAL OF THE AMERICAN CHEMICAL SOCIETY, vol. 68, no. 11, November 1946, pages 2282-2284.
8. JOURNAL OF THE ORGANIC CHEMISTRY, vol. 18, no. 12, December 1953, pages 1716-1722
9. JOURNAL OF THE ORGANOMETALLIC CHEMISTRY, vol. 3, no. 6, June 1965, pages 442-447
10. JOURNAL OF THE ORGANOMETALLIC CHEMISTRY, vol 73, no. 2, 2 Jul. 1974, pages 217-227
11. JOURNAL OF THE ORGANOMETALLIC CHEMISTRY, vol. 153, no. 3, 27 Jun. 1978, pages 289-298
12. JOURNAL OF THE ORGANOMETALLIC CHEMISTRY, vol. 25, no. 2, December 1970, pages 367-384
13. RUSSIAN JOURNAL OF GENERAL CHEMISTRY, vol. 63, no. 2-2, 1993, pages 267-268
14. JOURNAL OF THE AMERICAN CHEMICAL SOCIETY, vol. 70, no. 2, 5 Mar. 1948, pages 445-447
15. JOURNAL OF GENERAL CHEMISTRY OF THE USSR, vol. 38, no. 1, 1968, page 208
16. JOURNAL OF GENERAL CHEMISTRY OF THE USSR, vol. 61, no. 3, 1991, pages 686-688
17. PHOSPHORUS SULFUR AND THE RELATED ELEMENTS, vol. 17, 1983, pages 57-65

The above mentioned documents deal with reactions of Silanes and Siloxanes, but none of them offer a process to functionalize silanes or siloxanes as described in the present invention. The ease and high yields of the present invention is unmatched in all the processes described in the above documents.

### THE PRESENT INVENTION HAS THE FOLLOWING ADVANTAGES

Reduce the cost of incorporation of functional group in the siloxane by using a compound cheaper and easily available as compared to anhydrous HCl.
The present invention does not produce any effluents as compared to existing processes.
HMDS can be made from TMCS with recovery of HCl, by substituting the chloride with cheaper sulfate radical.
The sulphonated silane/siloxane produced is non volatile as compared to their chlorinated counterparts. So losses by evaporation can be minimum.
Even Ammonium sulphate produced as a by product during amination of sulfonated silane/siloxane is a fertilizer.

An existing process commercially used to make hydroxy terminated polydimethylsiloxane fluids is discussed below.

Process I:

Hydroxy terminated polydimethylsiloxane (reactive silicone oil) fluid is generally manufactured by the hydrolysis of dimethyldichlorosilane (M2). This hydrolysis generates a mixture of cyclic and linear chain silicones called hydrol. The cyclic silicones (DMC) can be distilled out of hydrol leaving behind hydroxy terminated low molecular weight silicones (LMS).

Process II:

A process of preparing silanol stopped siloxane by the ring opening polymerization of hexaorganotrisiloxane in the mixture of water and a volatile polar aprotic organic solvent in the presence of catalytic amounts of strong base, followed by neutralization, water washes and solvent recovery by distillation. (as described in U.S. Pat. No. 6,433,204 B).

Process III:

A process of preparing linear hydroxy end-terminated linear siloxanes by mixing chlorosiloxanes with volatile methyl siloxanes, followed by hydrolysis preferably in dilute HCl solution, and recovery of hydroxy terminated linear siloxanes. (as described in U.S. Pat. No. 6,316,655 B1).

The main drawback of manufacturing low. molecular weight hydroxy terminated silicone oil in case of process I is that the LMS so obtained can contain low levels of impurities, particularly trifunctionalities, due to traces of methyltrichlorosilane (M1) in M2.

The main drawback of manufacturing low molecular weight hydroxy terminated silicone oil in case of process II is as follows:

First, the need for hexaorganocyclotrisiloxane, which has to be produced and is difficult to handle. For example hexamethylcyclotrisiloxane, which is used to make hydroxy ended polydimethylsiloxane, is a solid at room temperature and has a melting point of ˜70° C.

Secondly, this process needs the presence of a solvent like acetone, which being highly volatile. can add to losses and/or high utility costs to prevent/reduce losses.

The main drawback of manufacturing low molecular weight hydroxy terminated silicone oil in case of process III is as follows:

First, the need for chlorosiloxanes, which has to be produced and are not easily commercially available.

Secondly. the preferable need for dilute aq. HCl, which again leads to the chlorine loop efficiency of chlorosilane plants (the general parent plant of all these products).

The present invention offers a method to conveniently manufacture pure LMS. This is because it is easy to convert even DMC into hydroxy terminated polydimethylsiloxane.

The process of the present invention can work efficiently with or without hexaorganocyclotrisiloxane (generally called D3), or mixtures of D3 with other siloxanes. Further, this process can work with or without solvents. When. preparing the amine modified siloxane such as Hexamethyldisilazane, the methodology used in the present invention will help to recover HCl from chlorosilanes as anhydrous or aqueous HCl without losing the reactive nature of parent chlorosilane, as this process offers a convenient way to produce compounds even from hydrolysed chlorosilanes. For example, while making HMDS, instead of making it by reacting TMCS with Ammonia, TMCS can be hydrolysed to make HMDO to recover the HCl, before making HMDS from HMDO conveniently using the process described here.

HMDS, which is extensively used as a silylating agent in the industry, can be made more economically using an environment friendly process described in this invention. Similarly hydroxy terminated polydimethylsiloxane fluids (reactive silicone oil) are extensively used for manufacture of silicone rubber and special purpose silicone fluids. This invention offers a convenient method of the manufacture of these fluids which can be of better quality than the conventionally produced fluids.

### OBJECT OF THE PRESENT INVENTION

The main object of the present invention is to modify a compound having a Si—O bond, to prepare functionalized silane or siloxane.

Yet another object of the present invention is to conveniently produce hydroxy-ended polysiloxanes.

Still another object of the present invention is to reduce the need for solvents in making hydroxy ended polysiloxanes.

Further, another object of the present invention is to recover hydrogen halide from halogen silanes/siloxane.

### DETAILED DESCRIPTION OF THE INVENTION

Accordingly, the present invention deals with a process of modifying a compound having Si—O—Si bond by breaking the said bond and incorporating desired functional group.

In another embodiment of the present invention is to incorporate a sulphate group to a compound having Si—O—Si bond, wherein the compound is selected from silane or siloxane and the sulphate group thus incorporated is further used as a door to add other functional groups.

Further, in another embodiment of the present invention the Si—O—Si linkage is converted to Si—SO₄ then converted to Si—NH, wherein the formation of sulphate group helped in the addition of —NH— linkage to the siloxane compound.

Still in another embodiment of the present invention, sulphonated silanes or siloxanes are further modified by reacting the same with Lewis base like ammonia or water to obtain hydroxy-terminated or amine modified silane or siloxane compounds.

Still in another object of the present invention, wherein a poly-dimethylsiloxane molecule is reacted with Sulfurtrioxide (SO₃) or Oleum then hydrolysed with water to form Hydroxy terminated polydimethylsiloxane fluid and dilute sulfuric acid.

Still in another embodiment of the present invention is to prepare a functionalized silane or siloxane, said invention comprising the steps:
1. contacting first compound containing Si—O—Si linkage with second compound capable of producing sulphate to produce a reaction mixture wherein the weight % of first and second compound can vary from 1 to 99%, to obtain modified Si—O—Si bond, and
2. mixing the reaction mixture of step (i) with a Lewis Base to incorporate a functional group to obtain modified Si—O—Si bond in silane or siloxane.

Further, in another embodiment of the present invention, wherein Si—O—Si bond containing compound is selected from. a group consisting of silane and siloxane.

Yet in another embodiment of the present invention, wherein sulfate producing compound in step (i) is selected from a group comprising SO₃, sulfuric acid, sulphurous acid and oleum.

Still in another embodiment of the present invention, wherein Lewis Base is selected from ammonia, ethylenediamine and water.

Further in another embodiment of the present invention, wherein the modified silanes is Hexamethyldisilazane.

Yet in another embodiment of the present invention, wherein the modified siloxanes is hydroxy terminated polydimethylsiloxane.

### EXAMPLES

The following examples are illustrative only and shall not be construed as limiting the invention.

### Example-1

500 gm mixture of 94% TMCS and rest HMDO is stirred in a 5 litre RB flask having 2 columns and reflux condenser attached to it. Column below the reflux condenser has a height of ˜400 mm and diameter of ˜1.5″. Column above the reflux condenser has a height of ˜150 mm and diameter of ˜1″. Both columns are filled with glass Raschig rings of ˜4 to 15 mm). 800 gm Hexane was added to the flask. The flask was heated to maintain a. temperature between 30 to 80° C. 240 gm Sulphuric acid was added slowly into the RB flask from the top of the column above the reflux condenser, the HCl evolved was vented to a water scrubber. At the end of sulfuric addition, the chloride content analysis of reaction mass showed 0.16% chloride. Then the reaction flask was kept half immersed in an ice bath; then 600 gm of Hexane was added to the solution, and later Ammonia vapours were passed into the system until the reaction mixture shows pH>7. Then 3 water washes were done and the organic layer was separated and collected. 13% HMDS was detected in the organic layer by gas chromatography

### Example-2

50 gm mixture of pure HMDO was taken in a stirred 2 litre RB flask. The flask was kept half immersed in ice bath. 70 gm Oleum (19.53%) was added slowly over a period of 1 hour maintaining the temperature in the range of 10 to 40° C. 500 gm Hexane was added to the flask. Ammonia vapours were passed into the stirred system until the reaction mixture shows pH>7. Then 3 water washes were done and the organic layer was separated and collected. 2.8% HMDS was detected in the organic layer by gas chromatography.

### Example-3

150 gm mixture of 100% HMDO was taken in a stirred 2 litre RB flask. The flask was kept half immersed in water bath. ˜70 gm SO₃ was added slowly over a period of 1 hour maintaining the temperature in the range of 40° C. to 55° C. Part of the mixture was separately vacuum distilled and Bis (trimethylsilyl) sulphate was obtained. In rest of the solution 500 gm Hexane was added. Ammonia vapours were passed into the stirred system until the reaction mixture shows pH>7. Then 3 water washes were done and the organic layer was separated and collected. 13% HMDS was detected in the organic layer by gas chromatography.

### Example-4

A 322 gm mixture of HMDO (50%) and toluene having no HMDS was taken in a stirred 2 litre RB flask. The flask was kept half immersed in water bath maintaining the temperature between 20° C. to 40° C. One litre flask containing 554 gm oleum was connected to the HMDO flask through a glass connector at the top of both flasks through a vertical, water-cooled condenser to drop condensed SO₃ into the HMDO flask. Oleum was then heated from 30° C. to 260° C. over a period of 45 minutes in the flask. Then 450 gm Hexane was added, followed by Ammonia vapours, which were passed into the stirred system until the reaction mixture shows pH>7. This amination was followed by 3 water washes. The organic layer obtained after the third wash was separated and collected. The organic layer contained 109 gm HMDS (as analysed by gas chromatography).

### Example-5

˜180 gm SO₃ was added to 3000 gram DMC in a stirred 5 litre RB flask. Then the mixture was mixed with water. The mixture was then given water washes till the oil layer was neutral. The oil was heated to 180° C. in vacuum >755 mm Hg for 2 hours This devolatilized silicone oil was of ˜80 cP viscosity. For a person skilled in the art of making silicone oils, the low viscosity in absence of any volatiles is a makes it clear the silicones are hydroxyl ended. Hence the hydroxy terminated low molecular weight silicone was formed. The hydroxy termination was checked by condensation polymerization test.

### Example-6

100 gm 20% Oleum was added to 100 gram DMC in a stirred 5 litre RB flask. Then the mixture was mixed with water. The mixture was then given water washes till the oil layer was neutral. This hydroxy terminated low molecular weight silicone oil was of ˜10 cP viscosity. (Hydroxy termination was checked by condensation polymerization test.)

### Example-7

˜180 gm SO₃ was added to 3000 gram DMC in a stirred 5 litre RB flask. 3000 grn Hexane was added to the mixture. Then the mixture was mixed with water. The mixture was then given water washes till the oil layer was neutral. The oil was heated to 200° C. for 1 hour to remove hexane. This silicone oil so obtained was of ˜20 cP viscosity. Hence the hydroxy terminated low molecular weight silicone was formed. Hydroxy termination was checked by condensation polymerization test.

We claim:

1. A process for preparing functionalized silane or siloxane, said process comprising the steps:
(i) contacting first compound containing Si—O—Si bond with second compound capable of producing sulphate to produce a reaction mixture wherein the weight % of first and second compound can vary from 1 to 99%, and
(ii) mixing the reaction mixture of step (i) with a Lewis Base to incorporate a functional group to obtain functionalized silane or siloxane.

2. A process as claimed in claim 1, wherein Lewis Base is selected from ammonia, ethylene diamine, NH₂CONH₂, C₆H₅NH₂, CH₃NH₂ and water.

3. A process as claimed in claim 1, wherein in step (ii), the functional group is selected from a group consisting of hydroxyl and amino group.

4. A process as claimed in claim 1, wherein the functionalized siloxane is hydroxy terminated polydimethylsiloxane and hexamethyldisilazane.

5. A process as claimed in claim 1, wherein sulphate-producing compound is selected from the group consisting of SO₃ and oleum.

6. A process as claimed in claim 1, wherein more than one sulfate producing compound is used for sulfonation of silane or siloxane.

7. A process as claimed in claim 1, wherein sulphate-producing compound is selected from the group consisting of SO₃, oleum, a mixture of SO₃ and oleum, a mixture of SO₃ and H₂SO₄, and a mixture of oleum and H₂SO₄.
